(19) United States
(12) Patent Application Publication
(10) Pub. No.: US 2026/0045642 A1
(43) Pub. Date: Feb. 12, 2026

(54) NONAQUEOUS ELECTROLYTE SECONDARY BATTERY LAMINATED SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Taiga ISHII, Niihama-shi (JP); Makoto Furukawa, Niihama-shi (JP)

(21) Appl. No.: 19/290,933

(22) Filed: Aug. 5, 2025

(30) Foreign Application Priority Data
Aug. 8, 2024 (JP) 2024-133268

(51) Int. Cl. H01M 50/451; H01M 10/0525; H01M 50/417; H01M 50/423; H01M 50/434; H01M 50/443; H01M 50/446; H01M 50/489

(52) U.S. Cl. CPC H01M 50/451; H01M 10/0525; H01M 50/417; H01M 50/423; H01M 50/434; H01M 50/443; H01M 50/446; H01M 50/489

(57) ABSTRACT

Provided is a nonaqueous electrolyte secondary battery laminated separator which has excellent heat resistance. The nonaqueous electrolyte secondary battery laminated separator of the present disclosure is constituted by a laminate of two or more layers and has a tensile modulus during heating of not less than 0.25 which is an inclination of stress with respect to an elongation percentage in a region in which the elongation percentage is 50% to 200% in a tension test in which the nonaqueous electrolyte secondary battery laminated separator is elongated at a speed of 10 mm/min in an MD under an atmosphere at 120° C. and stress [unit: N] applied at that time is measured.

This Nonprovisional application claims priority under 35 U.S.C. § 119 on Patent Application No. 2024-133268 filed in Japan on Aug. 8, 2024, the entire contents of which are hereby incorporated by reference.

### TECHNICAL FIELD

The present invention relates to a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, particularly lithium-ion secondary batteries, have high energy densities, and are thus in wide use as batteries for personal computers, mobile telephones, portable information terminals, and the like. Recently, such nonaqueous electrolyte secondary batteries have been developed as batteries for vehicles.

As a separator which is a member of the nonaqueous electrolyte secondary battery, a laminated separator which is constituted by a laminate of two or more layers has conventionally been used. Examples of the laminated separator include a laminated separator in which a porous layer such as a heat-resistant layer is laminated on one surface or both surfaces of a polyolefin porous film. In recent years, in accordance with an increase in capacity of batteries, there has been a higher demand for a laminated separator which has high-voltage resistance. As a laminated separator that satisfies the demand, a laminated separator has been developed which is disclosed in Patent Literature 1 and has characteristics indicated in (a) and (b) below:
(a) a porous layer is laminated on one surface or both surfaces of a polyolefin porous film; and
(b) the porous layer contains a filler and a block copolymer having a structure in which some aromatic rings are connected by a sulfonyl bond, specifically, an aramid resin which is a block copolymer having a structure that includes a block containing a large number of sulfonyl groups and a block containing a small number of sulfonyl groups.

### CITATION LIST

### Patent Literature

[Patent Literature 1]
Japanese Patent Application Publication Tokukai No. 2022-42995

### SUMMARY OF INVENTION

### Technical Problem

However, there is room for improvement in the conventional laminated separator, such as the laminated separator disclosed in Patent Literature 1, in terms of heat resistance such as shape retainability under a high-temperature environment.

### Solution to Problem

An aspect of the present invention is a nonaqueous electrolyte secondary battery laminated separator constituted by a laminate of two or more layers, in which
the nonaqueous electrolyte secondary battery laminated separator has a tensile modulus during heating of not less than 0.25 in a region in which an elongation percentage is 50% to 200% in a tension test, where
the tension test is a test in which the nonaqueous electrolyte secondary battery laminated separator is elongated at a speed of 10 mm/min in a machine direction (MD) under an atmosphere at 120° C., and stress [unit: N] applied at that time is measured,
the elongation percentage is a percentage [unit: %] of an elongation amount [unit: mm] of the nonaqueous electrolyte secondary battery laminated separator in the MD relative to a length [unit: mm] of the nonaqueous electrolyte secondary battery laminated separator in the MD before the elongation, and
the tensile modulus during heating is an inclination of an approximation line with respect stress-strain curve, the approximation line being obtained using a least squares method in the region in which the elongation percentage is 50% to 200%, and the stress-strain curve being obtained by plotting, where an X-axis value is the elongation percentage and a Y-axis value is the stress.

### Advantageous Effects of Invention

The laminated separator of an aspect of the present invention brings about an effect of having excellent heat resistance such as shape retainability under a high-temperature environment.

### DESCRIPTION OF EMBODIMENTS

The following description will discuss embodiments of the present invention. Note, however, that the present invention is not limited to the embodiments. Note that a numerical range “A to B” herein means “not less (lower) than A and not more (higher) than B” unless otherwise stated.

### Embodiment 1: Nonaqueous Electrolyte Secondary Battery Laminated Separator

A nonaqueous electrolyte secondary battery laminated separator of Embodiment 1 of the present invention is constituted by a laminate of two or more layers and has a tensile modulus during heating of not less than 0.25 in a region in which an elongation percentage is 50% to 200% in a tension test. Hereinafter the nonaqueous electrolyte secondary battery laminated separator of Embodiment 1 of the present invention is simply referred to as a “laminated separator”.

Here, the tension test is a test in which the nonaqueous electrolyte secondary battery laminated separator is elongated at a speed of 10 mm/min in a machine direction (MD) under an atmosphere at 120° C., and stress [unit: N] applied at that time is measured,
the elongation percentage is a percentage [unit: %] of an elongation amount [unit: mm] of the nonaqueous electrolyte secondary battery laminated separator in the MD relative to a length [unit: mm] of the nonaqueous electrolyte secondary battery laminated separator in the MD before the elongation, and
the tensile modulus during heating is an inclination of an approximation line with respect to a stress-strain curve, the approximation line being obtained using a least squares method in the region in which the elongation percentage is 50% to 200%, and the stress-strain curve being obtained by plotting, where an X-axis value is the elongation percentage and a Y-axis value is the stress.

In this specification, the “machine direction (MD)” refers to a transferring direction in production of a laminated separator. When the transferring direction for a laminated separator is unknown, a longitudinal direction (cylindrical type: a winding direction, continuous fanfold type: a folding-back direction) of the laminated separator is employed as the MD.

### <Tension Test>

In an embodiment of the present invention, an aspect of the tension test is not particularly limited, provided that the tension test is a test in which the laminated separator is elongated at a speed of 10 mm/min in the MD under an atmosphere at 120° C., and stress [unit: N] applied at that time is measured. The tension test can be carried out by, for example, a method in conformance with the JIS K7127 standard. Specifically, the tension test can be carried out by the method described in Examples.

In the tension test, the laminated separator itself may be used as an object to be measured. Alternatively, from the laminated separator, a measurement sample is obtained which retains the structure of the laminate of two or more layers in the laminated separator and which has a predetermined shape, and the measurement sample may be used as an object to be measured. A method of obtaining the measurement sample is not particularly limited. For example, a method can be employed in which a portion of the laminated separator is cut out or punched out, and the portion thus obtained is used as the measurement sample.

A shape and a size of the measurement sample are not particularly limited. Here, when carrying out the tension test, from the viewpoint of avoiding a breakage near the end of the measurement sample and accurately measuring stress, the shape of the measurement sample is preferably a dumbbell shape. The dumbbell shape is a shape which includes wide parts near the ends and a thin part in the middle, and in which a part where the wide part at the end changes to the thin part in the middle has a gentle curvature. Examples of the dumbbell shape include a shape defined by the dumbbell shape No. 3 described in JIS K6251.

Measurement of the elongation amount and elongation percentage in the tension test may be carried out on the basis of the length of the laminated separator or the measurement sample in the MD. Alternatively, the measurement may be carried out on the basis of a distance between marked lines provided in the laminated separator or the measurement sample. The marked lines are provided as two lines so that the marked lines are each perpendicular to a direction parallel to the MD and are equidistant from the center of the laminated separator or the measurement sample. When the measurement sample has a dumbbell shape, the marked lines are preferably provided in the thin part in the middle of the dumbbell-shaped measurement sample from the viewpoint of accurately measuring the elongation amount and elongation percentage.

Here, the length of the laminated separator or the measured sample in the MD, or the distance between the marked lines, prior to the elongation is regarded as X₀ [mm]. The length of the laminated separator or the measured sample in the MD, or the distance between the marked lines, after a predetermined time has elapsed from the start of the tension test is regarded as X₁ [mm]. In that case, the elongation amount [mm] after a predetermined time has elapsed from the start of the tension test is calculated according to Formula (1) below, and the elongation percentage [%] is calculated according to Formula (2) below.

$$Elongation amount [ mm ] = {X}_{1} [ mm ] - {X}_{0} [ mm ] \qquad ( 1 )$$

$$Elongation percentage [ \% ] = 100 \times ( {X}_{1} [ mm ] - {X}_{0} [ mm ] ) / {X}_{0} [ mm ] \qquad ( 2 )$$

A method of measuring stress is not particularly limited and can be carried out in a publicly known manner. During the tension test, the measurement of stress may be carried out every time the elongation amount is increased by a predetermined amount, for example, 0.02 mm or the like.

### <Tensile Modulus During Heating>

The tensile modulus during heating of an embodiment of the present invention is an inclination of an approximation line with respect to a stress-strain curve, the approximation line being obtained using a least squares method in a region in which the elongation percentage is 50% to 200%, and the stress-strain curve being obtained by plotting, where an X-axis value is the elongation percentage and a Y-axis value is the stress. The inclination is specifically a ratio of stress/elongation percentage.

In the laminated separator, typically, for example, a layer which has low heat resistance among the two or more layers changes in quality when the laminated separator is heated by heat generated due to an excessive voltage. Thus, the laminated separator is changed to an aspect in which a charge carrier cannot pass through, and safety of the nonaqueous electrolyte secondary battery is ensured. For example, when the layer which has low heat resistance contains a resin and has pores, the change in quality can be a change in which the resin constituting the layer is melted and the pores are blocked by the melted resin, or the like. Note that the layer which has low heat resistance is a layer which is easy to contract by heat.

During the change in quality, the easy-to-contract layer is contracted and, in addition, stress is applied in the in-plane direction of another layer which is more difficult to contract by heat than the easy-to-contract layer. This causes the another layer to be contracted as well, and the entire laminated separator is contracted. As a result, a short circuit may occur in the nonaqueous electrolyte secondary battery. Note that the contraction of the entire laminated separator falls under a plastic deformation.

Even when the easy-to-contract layer is contracted, the shape of the another layer is retained because a degree of contraction is smaller than the contraction of the easy-to-contract layer. Thus, the another layer has resistance force against stress applied in the in-plane direction by the contraction of the easy-to-contract layer. In other words, the another layer has resistance force against a plastic deformation of the easy-to-contract layer caused by the stress. When the resistance force is large, contraction of the another layer is small, and thus the entire laminated separator is difficult to contract. As a result, the laminated separator has high shape retainability during heating and has excellent heat resistance.

Here, in a laminated separator constituting a general nonaqueous electrolyte secondary battery, an easy-to-contract layer which changes in quality by heat generated due to an excessive voltage is typically softened at an atmospheric temperature of 120° C. in the tension test. Therefore, the easy-to-contract layer is softened, and the layer is greatly plastically deformed by stress applied in the tension test. The another layer which is laminated on the easy-to-contract layer is slightly plastically deformed, while exhibiting resistance to the plastic deformation of the easy-to-contract layer. Further, a region in which the elongation percentage is 50% to 200% in the tension test corresponds to a region in which the laminated separator is plastically deformed. Thus, the tensile modulus during heating is a parameter which indicates resistance force of the another layer against a plastic deformation of the easy-to-contract layer caused by the stress. A greater tensile modulus during heating means greater resistance force.

As the tensile modulus during heating increases, i.e., the resistance force increases, as described above, the laminated separator has higher shape retainability during heating and has more excellent heat resistance. From this point of view, the tensile modulus during heating is not less than 0.25, and preferably as large as possible, specifically, preferably not less than 0.26. An upper limit value of the tensile modulus during heating is not particularly limited and, for example, may be not more than 0.35 or may be not more than 0.40.

### <Configuration of Laminated Separator>

A configuration of the laminated separator is not particularly limited, provided that the laminated separator is constituted by a laminate of two or more layers. The laminated separator may have a configuration in which one surface or both surfaces of one layer are laminated with another layer. Hereinafter, the one layer is referred to as a “layer A”, and the other layer is referred to as a “layer B”. The layer A is, for example, a polyolefin porous film. The layer B is, for example, a porous layer. Thus, the laminated separator is, for example, a laminated separator having a structure in which a porous layer is laminated on one surface or on both surfaces of a polyolefin porous film. The following description will discuss, as the laminated separator, a laminated separator having a configuration in which a layer B is laminated on one surface or on both surfaces of a layer A. Here, the layer A and the layer B each correspond to at least one layer of the two or more layers.

### (Layer A)

A “polyolefin porous film” below means a polyolefin porous film as the layer A. The polyolefin porous film has therein many pores connected to one another. This allows a gas and a liquid to pass through the polyolefin porous film from one side to the other side. The polyolefin porous film can be a base material of the laminated separator. The polyolefin porous film can be one that imparts a shutdown function to the laminated separator by, when a battery generates heat, melting and thereby making the laminated separator non-porous.

Note, here, that a “polyolefin porous film” is a porous film which contains a polyolefin-based resin as a main component. The phrase “contains a polyolefin-based resin as a main component” means that the porous film contains the polyolefin-based resin in a proportion of not less than 50% by volume, preferably not less than 90% by volume, more preferably not less than 95% by volume, relative to the total amount of materials of which the porous film is made.

The polyolefin-based resin which the polyolefin porous film contains as a main component is not limited to any particular one. Examples of the polyolefin-based resin include homopolymers and copolymers which are each a thermoplastic resin and which are each obtained by polymerizing one or more monomers such as ethylene, propylene, 1-butene, 4-methyl-1-pentene, and/or 1-hexene. Specific examples of the homopolymers include polyethylene, polypropylene, and polybutene. Specific examples of the copolymers include an ethylene-propylene copolymer. The polyolefin porous film can be a layer which contains one type of polyolefin-based resin or can be alternatively a layer which contains two or more types of polyolefin-based resins. Among these polyolefin-based resins, polyethylene is more preferable because polyethylene makes it possible to prevent (shut down) a flow of an excessively large electric current at a lower temperature, and high molecular weight polyethylene which contains ethylene as a main component is particularly preferable. Note that the polyolefin porous film can contain a component other than polyolefin, provided that the component does not impair the function of the polyolefin porous film.

Examples of the polyethylene include low-density polyethylene, high-density polyethylene, linear polyethylene (ethylene-α-olefin copolymer), and ultra-high molecular weight polyethylene. Among these, ultra-high molecular weight polyethylene is further preferable. The polyolefin-based resin further preferably contains a high molecular weight component having a weight-average molecular weight of 5×10⁵ to 15×10⁶. In particular, the polyolefin-based resin which contains a high molecular weight component having a weight-average molecular weight of not less than 1,000,000 is more preferable, because such a polyolefin-based resin allows the polyolefin porous film and the nonaqueous electrolyte secondary battery laminated separator to each have increased strength.

The polyolefin porous film may have a multilayer structure constituted by two or more layers. Examples of the polyolefin porous film having a multilayer structure include a film in which a layer containing polyethylene as a main component and a layer containing polypropylene as a main component are laminated. The number of layers which are laminated is not particularly limited, and may be two layers constituted by polyethylene and polypropylene, or may be three layers constituted by a combination of polyethylene and polypropylene. By employing a multilayer structure containing polyethylene and polypropylene, it is possible to achieve both shutdown property and heat resistance.

The polyolefin porous film may have a cross-linked structure. The cross-linked structure can be introduced by, for example, using polyolefin which has been denatured with silane. The polyolefin porous film having a cross-linked structure has excellent heat resistance. Therefore, by combining with the layer B, the heat resistance of the nonaqueous electrolyte secondary battery laminated separator can be further improved. Note that the cross-linked structure may be formed between the polyolefin porous film and the layer B.

A thickness of the layer A is preferably 3 μm to 20 μm, more preferably 4 μm to 15 μm, and further preferably 4.5 μm to 15 μm. When the thickness is not less than 3 μm, strength of the laminated separator can be ensured. When the layer A is a polyolefin porous film and a thickness is not less than 3 μm, it is possible to sufficiently achieve demanded functions (such as shutdown function). The layer A which has a thickness of not more than 20 μm allows the resulting laminated separator to be thinner.

The pores in the polyolefin porous film each have a diameter of preferably not more than 0.1 μm, and more preferably not more than 0.06 μm. This makes it possible for the nonaqueous electrolyte secondary battery laminated separator to achieve sufficient ion permeability. Furthermore, this makes it possible to more prevent particles, which constitute an electrode, from entering the polyolefin porous film.

The layer A typically has a weight per unit area of preferably 2 g/m² to 20 g/m², and more preferably 2.5 g/m² to 12 g/m² so that the battery can have a higher weight energy density and a higher volume energy density.

The layer A has air permeability of preferably 30 s/100 mL to 500 s/100 mL, and more preferably 50 s/100 mL to 300 s/100 mL, in terms of Gurley values. This allows the laminated separator to achieve sufficient ion permeability.

The polyolefin porous film has a porosity of preferably 20% by volume to 80% by volume, and more preferably 30% by volume to 75% by volume. This makes it possible to (i) increase the amount of an electrolyte retained in the polyolefin porous film and (ii) absolutely prevent (shut down) a flow of an excessively large electric current at a lower temperature.

A method of producing the polyolefin porous film is not limited to a particular method, and any publicly known method can be employed. The production method can be, for example, a method which involves adding a filler to a thermoplastic resin, forming the resulting mixture into a film, and then removing the filler, as disclosed in Japanese Patent No. 5476844.

As a specific example, the following description will discuss a production method in a case in which a polyolefin porous film is formed from a polyolefin-based resin that contains ultra-high molecular weight polyethylene and low molecular weight polyolefin which has a weight-average molecular weight of not more than 10,000. In this case, it is preferable to produce the polyolefin porous film by a method including the following steps (1) through (4), from the viewpoint of production costs:
(1) kneading 100 parts by weight of ultra-high molecular weight polyethylene, 5 parts by weight to 200 parts by weight of low molecular weight polyolefin which has a weight-average molecular weight of not more than 10,000, and 100 parts by weight to 400 parts by weight of an inorganic filler such as calcium carbonate to obtain a polyolefin-based resin composition;
(2) forming the polyolefin-based resin composition into a sheet;
(3) removing the inorganic filler from the sheet which has been obtained in the step (2); and
(4) stretching the sheet which has been obtained in the step (3). Alternatively, the polyolefin porous film may be produced by a method disclosed in any of the above-listed Patent Literatures.

The polyolefin porous film can be alternatively a commercially available product which has the above-described characteristics.

### (Layer B)

At least one layer (e.g., the layer B) of the two or more layers can be a heat-resistant layer. Note that the heat-resistant layer herein means a layer which has a melting temperature higher than a layer (such as the layer A) which constitutes the laminated separator and is not the layer B.

At least one layer (e.g., the layer B) of the two or more layers can be a layer containing a resin. Examples of the resin are not particularly limited and include one or more types of resins selected from the group consisting of polyolefin, a (meth)acrylate-based resin, a fluorine-containing resin, a polyamide-based resin, a polyester-based resin, and a water-soluble polymer. The resin may be one type of resin or may be a mixture obtained by combining two or more types of resins. For example, when a mixture obtained by mixing a polyamide-based resin which has excellent heat resistance with a (meth)acrylate-based resin and/or a fluorine-containing resin each of which has adhesiveness is employed as the resin, a layer B which achieves both heat resistance and adhesiveness can be obtained. At this time, the presence form of the (meth)acrylate-based resin and/or the fluorine-containing resin is not particularly limited. The resins may be in particle form, may be present in a mixed state with the polyamide-based resin, or may be segregated on the surface of the layer B.

Examples of the polyolefin are not particularly limited and include polyethylene, polypropylene, polybutene, an ethylene-propylene copolymer, and the like.

Examples of the (meth)acrylate-based resin are not particularly limited and include methyl acrylate, n-butyl acrylate, 2-ethylhexyl acrylate, and the like.

Examples of the fluorine-containing resin are not particularly limited and include: polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; and a fluorine-containing rubber having a glass transition temperature of not more than 23° C. among the fluorine-containing resins.

Examples of the polyamide-based resin are not particularly limited and include aramid resins such as aromatic polyamide and wholly aromatic polyamide.

Examples of the polyester-based resin are not particularly limited and include aromatic polyester, liquid crystal polyester, and the like. Examples of the aromatic polyester are not particularly limited and include polyarylate and the like.

Examples of the water-soluble polymer include polyvinyl alcohol, polyethylene glycol, cellulose ether, sodium alginate, polyacrylic acid, polyacrylamide, polymethacrylic acid, and the like.

Examples of the aramid resin are not particularly limited and include a block copolymer including a block A containing, as a main component, units each represented by Formula (3) below and a block B containing, as a main component, units each represented by Formula (4) below.

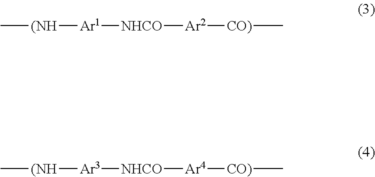

where: Ar¹, Ar², Ar³, and Ar⁴ may each vary from unit to unit; Ar¹, Ar², Ar³, and Ar⁴ are each independently a divalent group having one or more aromatic rings; not less than 50% of all Ar¹ each have a structure in which two aromatic rings are connected by a sulfonyl bond; not more than 50% of all Ar³ each have a structure in which two aromatic rings are connected by a sulfonyl bond; and 10% to 70% of a total of all Ar¹ and Ar³ have a structure in which two aromatic rings are connected by a sulfonyl bond.

The units each represented by Formula (3) account for preferably not less than 80%, more preferably not less than 90%, and further preferably not less than 95% of all units contained in the block A in the block copolymer. The block A is represented by the units each represented by Formula (3), in its entirety, except for the terminals. The units each represented by Formula (4) account for preferably not less than 80%, more preferably not less than 90%, and further preferably not less than 95% of all units contained in the block B. The block B is represented by the units each represented by Formula (4), in its entirety, except for the terminals.

In Formulae (3) and (4), Ar¹, Ar², Ar³, and Ar⁴ may each vary from unit to unit. Ar¹, Ar², Ar³, and Ar⁴ are each independently a divalent group having one or more aromatic rings.

In this specification, an “aromatic ring” indicates a cyclic compound which satisfies the Hückel's rule. Examples of the aromatic ring include benzene, naphthalene, anthracene, azulene, pyrrole, pyridine, furan, and thiophene. The aromatic ring can be composed only of carbon atoms and hydrogen atoms. The aromatic ring can be a benzene ring or a condensed ring derived from two or more benzene rings (such as naphthalene and anthracene).

In the block A, at least some of all Ar¹ have a structure in which two aromatic rings are connected by a sulfonyl bond. In the block B, Ar³ may have a structure in which two aromatic rings are connected by a sulfonyl bond. A lower limit of a proportion of a total of Ar¹ and Ar³ having the structure in which two aromatic rings are connected by a sulfonyl bond to a total of all Ar¹ and Ar³ is not less than 10%, preferably not less than 30%, more preferably not less than 35%, further preferably not less than 40%. An upper limit of the proportion is not more than 70%, preferably not more than 65%, and more preferably not more than 60%.

In the block A, a proportion of Ar¹ having the structure in which two aromatic rings are connected by a sulfonyl bond to all Ar¹ is not less than 50%, preferably not less than 80%, and more preferably not less than 90%. In the block A, all Ar¹ may each have the structure in which two aromatic rings are connected by a sulfonyl bond.

In the block B, a proportion of Ar³ having the structure in which two aromatic rings are connected by a sulfonyl bond to all Ar³ is not more than 50%, preferably not more than 20%, and more preferably not more than 10%. In the block B, all Ar³ may each be a structure other than the structure in which two aromatic rings are connected by a sulfonyl bond.

Thus, it can be said that the block A is a block which contains a relatively large number of sulfonyl groups, whereas the block B is a block which contains a relatively small number of sulfonyl groups. When a block copolymer having such two types of blocks is employed as the resin, it is possible to obtain a layer B which can achieve both high-voltage resistance and adhesiveness and a laminated separator which includes the layer B.

Examples of the structure in which two aromatic rings are connected by a sulfonyl bond are not particularly limited and include 4,4′-diphenylsulfonyl, 3,4′-diphenylsulfonyl, 3,3′-diphenylsulfonyl, and the like.

Examples of the structure other than the structure in which two aromatic rings are connected by a sulfonyl bond are not particularly limited and include the following structure.

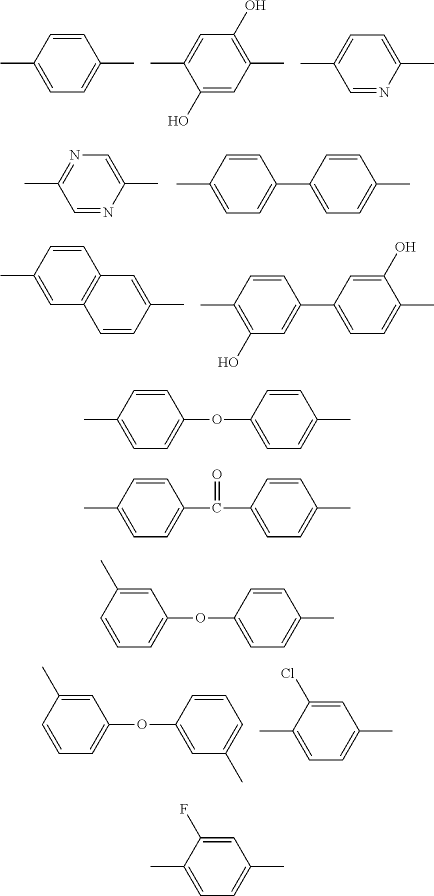

At least some of the units which are contained in the block A and which are each represented by Formula (3) can be 4,4′-diphenylsulfonyl terephthalamide. In that case, a lower limit of a proportion of 4,4′-diphenylsulfonyl terephthalamide to the units which are contained in the block A and which are each represented by Formula (3) is preferably not less than 50%, more preferably not less than 80%, and further preferably not less than 90%. Monomers from which 4,4′-diphenylsulfonyl terephthalamide is formed are readily available, and also 4,4′-diphenylsulfonyl terephthalamide is easy to handle.

At least some of the units which are contained in the block B and which are each represented by Formula (4) can be paraphenylene terephthalamide. In that case, a lower limit of a proportion of paraphenylene terephthalamide to the units which are contained in the block B and which are each represented by Formula (4) is preferably not less than 50%, more preferably not less than 80%, and further preferably not less than 90%. Monomers from which paraphenylene terephthalamide is formed are readily available, and also paraphenylene terephthalamide is easy to handle.

The block copolymer may have a structure which is constituted by units other than the units each represented by Formula (3) or (4). Examples of such a structure include a polyimide backbone.

The number of blocks which the block copolymer has is not limited to any particular number. The block copolymer can have, for example, a diblock structure such as “block A-block B” or a triblock structure such as “block A-block B-block A” or “block B-block A-block B”. For example, the block copolymer can have a tetrablock structure such as “block A-block B-block A-block B”. Among the above structures, the triblock structure of “block B-block A-block B” is preferable as the structure of the block copolymer.

In one molecule of the block copolymer, the number of the units which are contained in the block A and which are each represented by Formula (3) is preferably 10 to 1000, and more preferably 20 to 300. When the number of the units each represented by Formula (3) falls within the above range, a sufficiently large number of sulfonyl groups are contained in a molecule, and accordingly the layer B and the laminated separator including the layer B have enhanced high-voltage resistance. In one molecule of the block copolymer, the number of the units which are contained in the block B and which are each represented by Formula (4) is preferably 10 to 500, and more preferably 15 to 200. When the number of the units each represented by Formula (4) falls within the above range, the layer B has high adhesiveness with respect to another layer (such as the layer A) or an electrode.

Note, here, that the number of the units each represented by Formula (3) and the number of the units each represented by Formula (4), which numbers are indicated as preferable numbers, are each the number in a molecule corresponding to the mode in the molecular weight distribution of the block copolymer. The molecular weight distribution of the block copolymer can be experimentally obtained by, for example, gel permeation chromatography.

The molecular weight of the block copolymer is preferably 0.5 dL/g to 5 dL/g, and more preferably 0.8 dL/g to 2.5 dL/g, when expressed as an intrinsic viscosity. When the molecular weight falls within the above range, it is possible to achieve both good coatability in production of a layer B (described later) and strength of the resulting layer B and a laminated separator including the layer B.

When the layer B contains the block copolymer, a proportion of the block copolymer is preferably 10% by weight to 80% by weight, and more preferably 30% by weight to 60% by weight, when the weight of the layer B is regarded as 100% by weight. When the proportion falls within the above range, it is possible to sufficiently impart, to the layer B and the laminated separator including the layer B, high-voltage resistance derived from electron-withdrawing property of the sulfonyl group contained in the block copolymer.

From the viewpoint of suitably increasing the tensile modulus during heating, it is preferable to select, as a combination of a constituent component of the layer A and a constituent component of the layer B, a combination of components having high affinity for each other. By selecting the combination of components having high affinity, it is possible to strengthen an interaction (i.e., a bond) between the layer A and the layer B, and to improve adhesiveness between the layer A and the layer B. Here, when adhesiveness between the layer A and the layer B is high and any one layer of the layer A and the layer B is contracted, resistance force of the other layer of the layer A and the layer B against the contraction is increased. Thus, by selecting a combination of components having high affinity, it is possible to improve the resistance force, and consequently the tensile modulus during heating can be suitably increased and controlled within a suitable range of not less than 0.25.

The combination of components having high affinity is not particularly limited. For example, polyolefin is selected as a constituent component of the layer A and, as a constituent component of the layer B, an aramid resin is selected which contains the foregoing block copolymer and has the following characteristics.
Containing a large amount of (i) homopolymers each having a structure identical with that of the block A and having low reactivity at terminals thereof with monomers and other polymers and (ii) cyclic components described later.

Hereinafter the homopolymer having a structure identical with that of the block A and having low reactivity at terminals thereof with monomers and other polymers is referred to as a “homopolymer A”. The aramid resin which contains the foregoing block copolymer and has the above characteristics is referred to as a “modified aramid resin”.

Here, selecting polyolefin as a constituent component of the layer A means, for example, selecting the polyolefin porous film as the layer A. Selecting the modified aramid resin as a constituent component of the layer B means, for example, selecting, as the layer B, a porous layer containing the modified aramid resin.

Note that the homopolymer A is a by-product which can be generated at the time of preparation of the block copolymer. The homopolymer A specifically has a structure in which a terminal group is a carboxy group: C(═O)—OH.

When the block copolymer is prepared, as another by-product, a homopolymer can be generated which has a structure identical with that of the block B and has low reactivity at terminals thereof with monomers and other polymers. Hereinafter the homopolymer having a structure identical with that of the block B and having low reactivity at terminals thereof with monomers and other polymers is referred to as a “homopolymer B”. The homopolymer A has higher affinity for polyolefin than the block copolymer constituted by the block A and the block B, and than the homopolymer B.

A part of the homopolymer A can be changed to a cyclic component by condensation of both terminals. Thus, the aramid resin containing the block copolymer can contain, in addition to the homopolymer A, the cyclic component. Here, the cyclic component has high affinity for polyolefin, as with the homopolymer A.

The modified aramid resin contains a large amount of the homopolymers A and the cyclic components, and thus has high affinity for polyolefin. Therefore, when, in the laminated separator, the layer A is a polyolefin porous film and the layer B is a porous layer containing the modified aramid resin, the tensile modulus during heating of the laminated separator can be controlled within a suitable range of not less than 0.25.

The terminal of the homopolymer A is a carboxy group. Thus, the modified aramid resin contains a large amount of carboxy groups that are polar functional groups, and has improved affinity for a nonaqueous electrolyte. Therefore, the laminated separator including the layer B containing the modified aramid resin can improve a rate characteristic of a nonaqueous electrolyte secondary battery including the laminated separator.

The homopolymer A and the cyclic component have higher affinity for a solvent generally used in a coating solution such as, for example, N-methyl-2-pyrrolidone (hereafter referred to as “NMP”), as compared with the block copolymer constituted by the block A and the block B, and as compared with the homopolymer B. Thus, the homopolymer A and the cyclic component is more soluble in the solvent. Therefore, in formation of the layer B, first, the block copolymer constituted by the block A and the block B and the homopolymer B are deposited to form a network structure, and subsequently the homopolymer A is deposited near the network structure. By the deposition in such an aspect, a layer which has large holes is obtained as the layer B, and consequently air permeability of the layer B and the laminated separator including the layer B is decreased. Therefore, the laminated separator including the layer B containing the modified aramid resin has a low value of air permeability and is excellent in terms of air permeability.

At least one layer (e.g., the layer B) of the two or more layers can contain a filler. When the layer B contains a filler, an amount of the filler is preferably 20% by weight to 90% by weight, and more preferably 30% by weight to 80% by weight, relative to 100% by weight of the layer B, i.e., the entire layer containing the filler. When the contained amount of the filler falls within the above range, the layer B and the laminated separator including the layer B can have sufficient ion permeability.

Examples of types of the filler include organic fillers, inorganic fillers, and mixtures thereof.

Examples of the organic fillers include: homopolymers and copolymers which are each obtained from one or more monomers such as styrene, vinyl ketone, acrylonitrile, methyl methacrylate, ethyl methacrylate, glycidyl methacrylate, glycidyl acrylate, and/or methyl acrylate; fluorine-based resins such as polytetrafluoroethylene, a tetrafluoroethylene-hexafluoropropylene a copolymer, tetrafluoroethylene-ethylene copolymer, and polyvinylidene fluoride; melamine resins; urea resins; polyolefins; and polymethacrylates. Each of these organic fillers may be used alone or two or more of these organic fillers may be alternatively used in combination. Among these organic fillers, a polytetrafluoroethylene powder is preferable in terms of chemical stability. Polyolefin may be used as an organic filler from the viewpoint of improving shutdown property of the nonaqueous electrolyte secondary battery laminated separator. When polyolefin is used as an organic filler, it is possible to impart shutdown property to the layer B.

Examples of the inorganic fillers include materials each made of an inorganic matter such as metal oxide, metal nitride, metal carbide, metal hydroxide, carbonate, or sulfate. Specific examples of the inorganic fillers include: powders of aluminum oxide (such as alumina), boehmite, silica, titania, magnesia, barium titanate, barium sulfate, magnesium hydroxide, aluminum hydroxide, calcium carbonate, and the like; and minerals such as mica, zeolite, kaolin, and talc. Each of these inorganic fillers may be used alone or two or more of these inorganic fillers may be alternatively used in combination. Among these inorganic fillers, aluminum oxide is preferable in terms of chemical stability.

The shape of each of particles of the filler can be a substantially spherical shape, a plate shape, a columnar shape, a needle shape, a whisker shape, a fibrous shape, or the like. The particles can have any shape. The particles preferably have a substantially spherical shape, because such particles facilitate formation of uniform pores.

The average particle diameter of the filler is preferably 0.01 μm to 1 μm, more preferably 0.01 μm to 0.8 μm. A filler having an average particle diameter of not less than 0.01 μm facilitates enlargement of diameters of pores in the layer B. Therefore, even when the separator is compressed in the battery, ion permeability is less likely to decrease. Moreover, unevenness is easily formed on the surface of the layer B, and therefore it is possible to improve slipperiness of the separator. Meanwhile, when the average particle diameter of the filler is not more than 1 μm, it is possible to improve heat resistance of the separator and to reduce a thickness the separator. In order to achieve both of these characteristics, fillers having different average particle diameters may be used in combination, or a filler having a wide particle diameter distribution may be used. In this specification, the “average particle diameter of the filler” indicates a volume-based average particle diameter (D50) of the filler. “D50” means a particle diameter having a value at which a cumulative value reaches 50% in a volume-based particle diameter distribution. D50 can be measured with use of, for example, a laser diffraction particle diameter analyzer (product names: SALD2200, SALD2300, etc., manufactured by Shimadzu Corporation).

The layer B may contain a component different from the resin and the filler, as long as such a component does not prevent the object of the present invention from being attained. The other component to be contained may be, for example, an additive which is generally used in a nonaqueous electrolyte secondary battery separator. The other component may be one type or may be a mixture of two or more types.

Examples of the additive include flame retardants, antioxidants, surfactants, waxes, and the like. When the layer B is prone to static electricity, electrification of the layer B can be suppressed by adding an antistatic agent. It is also possible to further increase safety and heat resistance of the separator by adding a flame retardant and/or a cross-linking agent.

### (Physical Properties of Layer B and Laminated Separator, and the Like)

The laminated separator has an air permeability of preferably not more than 500 s/100 mL, and more preferably not more than 300 s/100 mL, in terms of Gurley values. The layer B has an air permeability of preferably not more than 400 s/100 mL, and more preferably not more than 200 s/100 mL, in terms of Gurley values. When the air permeabilities of the laminated separator and/or the layer B fall within the above respective ranges, the laminated separator has sufficient ion permeability.

When the laminated separator is constituted only by the layer A and the layer B, the air permeability of the layer B is calculated, for example, by Y−X, where X represents the air permeability of the layer A and Y represents the air permeability of the laminated separator. When the layer B is a porous layer containing a resin, the air permeability of the layer B can be adjusted by, for example, adjusting the intrinsic viscosity of the resin and/or the weight per unit area of the layer B. Generally, as an intrinsic viscosity of a resin decreases, a Gurley value of a porous layer containing the resin tends to decrease. As a weight per unit area of a porous layer decreases, a Gurley value of the porous layer tends to decrease.

From the viewpoint of controlling the air permeability to a suitable range, the weight per unit area of the layer B is preferably 0.6 g/m² to 2.5 g/m², and more preferably 0.8 g/m² to 2.0 g/m².

The layer B has a thickness of preferably not more than 10 μm, more preferably not more than 7 μm, and further preferably not more than 5 μm (upper limit). The layer B has a thickness of preferably not less than 0.3 μm, more preferably not less than 0.5 μm, and further preferably not less than 0.6 μm (lower limit).

The layer B may be provided on one surface of the layer A or on both surfaces of the layer A. One layer B and the other layer B which are provided on both surfaces of the layer A may each have the same film thickness, weight per unit area, and porosity, or may be different in film thickness, weight per unit area, and porosity.

In the laminated separator, at least one layer of the two or more layers may be a layer C which is a layer different from the layer A and the layer B. Examples of the layer C are not particularly limited and include an adhesive layer, a heat-resistant porous layer different from the layer B, a slippery layer for the purpose of improving slipperiness of a separator, a layer containing organic particles such as polyolefin for the purpose of imparting shutdown property, an antistatic layer, and a publicly known layer such as a protective layer. The laminated separator, for example, may contain the layer C as needed, in addition to the layer A and the layer B, provided that the layer C does not prevent the object of the present invention from being attained. The heat-resistant porous layer different from the layer B indicates that types of resin and filler, an amount of filler used, and the like are different from those of the layer B. When the layer C is a heat-resistant porous layer different from the layer B, the resin and filler and the amount of the filler used which are exemplified for the layer B can be applied to the layer C. The slippery layer is a layer containing an anti-blocking agent, a layer containing a filler, or the like. The slippery layer provides unevenness to the surface so as to improve slipperiness of the separator.

The layer C may be provided on one surface or on both surfaces of the laminated separator. If the laminated separator includes layers B on both surfaces of the layer A, the layer C may be provided on both the layers B or on one of the layers B. If the laminated separator includes a layer B only on one surface of the layer A, the layer C may be provided on the layer B or on the other surface of the layer A where the layer B is not provided. The layer C may be provided on the outermost layer of the laminated separator.

Herein, the adhesive layer refers to a layer having adhesiveness. The adhesive layer can be provided on a surface of the laminated separator that comes into contact with an electrode. Examples of a component that contributes to the adhesiveness in the adhesive layer encompass an acrylic resin, a PVDF-based resin, and the like. The acrylic resin can be, for example, those described in paragraphs [0072] through [0088] in Japanese Patent Application Publication Tokukai No. 2024-006988. The PVDF-based resin can be, for example, those described in paragraphs [0017] through [0022] in Japanese Patent Application Publication Tokukai No. 2017-168419. The acrylic resin and the PVDF-based resin may be used alone or in combination. The adhesive layer may contain a filler in addition to a component that contributes to adhesiveness. The filler can be similar to the filler which is added to the layer B. A state in which the adhesive layer is present is not particularly limited. A component that contributes to adhesiveness may be present in a particle form or may be present as a homogeneous coating layer. An adhesive layer may be present in a dot form or in a stripe form by pattern coating. By providing the adhesive layer, the separator is fixed to the electrode via the adhesive layer. Therefore, it is possible to improve handleability and heat resistance of the electrode laminated body. Furthermore, the presence of the adhesive layer in a particle form, a dot form, or a stripe form makes it possible to suppress a decrease in ion permeability of the laminated separator.

### <Method of Producing Laminated Separator>

For example, the laminated separator can be produced by forming, on one surface or on both surfaces of the layer A, the layer B with use of a coating solution obtained by dissolving or dispersing, in a solvent, components such as the resin and the filler which constitute the layer B. Examples of a method of forming the coating solution include a mechanical stirring method, an ultrasonic dispersion method, a high-pressure dispersion method, and a media dispersion method. The solvent can be, for example, N-methylpyrrolidone, N, N-dimethylacetamide, N,N-dimethylformamide, or the like.

A method of producing the laminated separator can be, for example, a method which involves preparing the coating solution, applying the coating solution to the layer A, and then drying the coating solution so that the layer B is formed on the layer A.

As a method of coating the layer A with the coating solution, a publicly known coating method, such as a knife coater method, a blade coater method, a bar coater method, a gravure coater method, or a die coater method, can be employed.

The solvent (dispersion medium) is generally removed by a drying method. Examples of the drying method include natural drying, air-blow drying, heat drying, and drying under reduced pressure. Note, however, that any method can be employed, provided that the solvent (dispersion medium) can be sufficiently removed. Note also that drying can be carried out after the solvent (dispersion medium) contained in the coating solution is replaced with another solvent. A method of replacing the solvent (dispersion medium) with another solvent and then removing the another solvent can be specifically as follows: (i) the solvent (dispersion medium) is replaced with a poor solvent having a low boiling point, such as water, alcohol, or acetone, (ii) a solute is deposited, and (iii) drying is carried out.

### (Method for Controlling Tensile Modulus During Heating)

In the foregoing method of producing a laminated separator, by controlling the tensile modulus during heating to a large value of not less than 0.25, a laminated separator of an embodiment of the present invention can be produced. A method of controlling the tensile modulus during heating to a large value of not less than 0.25 is not particularly limited. For example, it is possible to employ a method in which the number of strong bonds between layers in the two or more layers is increased to improve adhesiveness. Specific examples of a method of increasing the number of strong bonds can be a method in which, as a combination of a constituent component of the layer A and a constituent component of the layer B, a combination of components having high affinity for each other is selected. As a more specific method, it is possible that, in the method of producing a laminated separator, the polyolefin porous film is used as the layer A and, as the coating solution, a coating solution is used which contains the modified aramid resin and optionally the filler.

The following description will discuss a method of preparing the modified aramid resin. First, a method of preparing an aramid resin containing the block copolymer can be, for example, a method according to the procedure indicated in steps 1 and 2 below. With this method, an aramid resin can be prepared which contains a block copolymer having a diblock structure of “block A-block B”. An aramid resin containing a block copolymer having another block structure can be also prepared by applying the following procedure and production conditions.
1. A diamine represented by NH₂—Ar¹—NH₂ and a dicarboxylic halide represented by X—(O═)C—Ar²—C(═O)—X (X is a halogen atom such as F, Cl, Br, and I), which serve as monomers, are polymerized according to a publicly known polymerization method for forming an aromatic polyamide. In this manner, the block A, which contains the units each represented by Formula (3), is synthesized.
2. After synthesis of the block A is completed, a diamine represented by NH₂—Ar³—NH₂ and a dicarboxylic halide represented by X—(O═)C—Ar⁴—C(═O)—X (X is a halogen atom such as F, Cl, Br, and I), which serve as monomers, are polymerized according to a publicly known polymerization method for forming an aromatic polyamide. In this manner, the block B, which contains the units each represented by Formula (4), is synthesized in the state of being connected to the block A.

Then, with a method in which production conditions indicated in (i) and (ii) below are satisfied in the method according to the procedure indicated in steps 1 and 2, it is possible to prepare a modified aramid resin which can be suitably used in production of the laminated separator. Hereinafter the method in which production conditions indicated in (i) and (ii) below are satisfied in the method according to the procedure indicated in steps 1 and 2 is referred to as a “modified aramid resin preparation method”.
(i) In synthesis of the block A indicated in the step 1, a water content of the solvent used is set to be higher than a water content in the conventional method of producing a block copolymer (e.g., a water content of preferably not less than 400 ppm, more preferably not less than 450 ppm).
(ii) In synthesis of the block A indicated in the step 1, a mixing ratio (i.e., a molar ratio) between the diamine and the dicarboxylic halide is set to a range close to 1.00 (e.g., preferably 0.99 to 1.01, more preferably 0.995 to 1.005).

Here, the aramid resin which contains a block copolymer and is produced by the method indicated by steps 1 and 2 can contain, as by-products, the homopolymer A, the homopolymer B, and the cyclic component.

When the foregoing condition (i) is satisfied, in the step 1, C(═O)—X (X is a halogen atom such as F, Cl, Br, and I), which is a terminal group of the block A, and a water molecule (H₂O) react with each other, so that a reaction easily occurs in which the terminal group becomes a carboxy group: C(═O)—OH. Here, the carboxy group falls under a group which has low reactivity with monomers and other polymers. Thus, an amount of the homopolymer A contained in the block copolymer is increased. A part of the homopolymer A is the cyclic component. Therefore, when a contained amount of the homopolymer A is large, a contained amount of the cyclic component is also large.

Thus, when the above condition (i) is satisfied, a modified aramid resin containing large amounts of the homopolymer A and the cyclic component can be suitably prepared.

When the condition (i) is satisfied, a C(═O)—X group, which is a reaction site, easily becomes a carboxy group which has low reactivity with monomers and other polymers during the polymerization reaction to produce the block A. Therefore, when the condition (i) is satisfied, a degree of polymerization of the block A is decreased, and consequently a weight-average molecular weight of the resulting modified aramid resin is easily decreased. Here, when the modified aramid resin has a low weight-average molecular weight, in the method of producing the laminated separator, the modified aramid resin is highly soluble in the solvent and is difficult to deposit. This may prevent formation of a layer B and may thus prevent production of a laminated separator.

When the mixing ratio is close to 1.00, however, the number of monomers which constitute terminal groups of the block A is small, and a degree of polymerization of the block A is heightened. This increases a weight-average molecular weight of the resulting modified aramid resin. Thus, by satisfying the condition (ii), even when the condition (i) is satisfied, the weight-average molecular weight of the resulting modified aramid resin can be increased to an extent that the layer B can be suitably formed and the laminated separator can be suitably produced. Thus, with the modified aramid resin preparation method, it is possible to prepare a modified aramid resin which can be suitably used in production of the laminated separator.

As a method of increasing the number of strong bonds between layers in the two or more layers, an example in which an aramid resin is used has been described. As long as affinity between the layer A and the layer B can be increased, it is possible to employ a method in which the aramid resin is not used. For example, an activation treatment is carried out on the surface of the layer A, and a filler contained in the layer B is caused, through a coupling treatment or the like, to have a functional group which has high affinity for the layer A. This may also make it possible to increase the affinity between the layer A and the layer B.

### Embodiment 2: Nonaqueous Electrolyte Secondary Battery Member, Embodiment 3: Nonaqueous Electrolyte Secondary Battery

A nonaqueous electrolyte secondary battery member of Embodiment 2 of the present invention includes a positive electrode, the nonaqueous electrolyte secondary battery laminated separator of Embodiment 1 of the present invention, and a negative electrode which are disposed in this order. A nonaqueous electrolyte secondary battery of Embodiment 3 of the present invention includes the nonaqueous electrolyte secondary battery laminated separator of Embodiment 1 of the present invention.

Thus, the nonaqueous electrolyte secondary battery member of an embodiment of the present invention suitably prevents a short circuit caused due to contraction of the separator by heat generated during operation, and thus brings about an effect of providing a nonaqueous electrolyte secondary battery which has excellent safety. In the nonaqueous electrolyte secondary battery of an embodiment of the present invention, the short circuit is suitably prevented, and thus an effect of excellent safety is brought about.

The nonaqueous electrolyte secondary battery of an embodiment of the present invention typically has a structure in which a negative electrode and a positive electrode face each other with the laminated separator sandwiched therebetween. The nonaqueous electrolyte secondary battery is configured such that a battery element, which includes the structure and an electrolyte with which the structure is impregnated, is enclosed in an exterior member. The nonaqueous electrolyte secondary battery is, for example, a lithium ion secondary battery which achieves an electromotive force through doping with and dedoping of lithium ions.

### <Positive Electrode>

Examples of the positive electrode include a positive electrode sheet having a structure in which an active material layer including a positive electrode active material and a binding agent is formed on a current collector. The active material layer may further contain an electrically conductive agent.

Examples of the positive electrode active material include materials each capable of being doped with and dedoped of lithium ions.

Examples of the materials include lithium complex oxides each containing at least one type of transition metal such as V, Ti, Cr, Mn, Fe, Co, Ni, and/or Cu. Examples of the lithium complex oxides include lithium complex oxides each having a layer structure, lithium complex oxides each having a spinel structure, and solid solution lithium-containing transition metal oxides each constituted by a lithium complex oxide having both a layer structure and a spinel structure. Examples of the lithium complex oxides also include lithium cobalt complex oxides and lithium nickel complex oxides. Further, examples of the lithium complex oxides also include lithium complex oxides each obtained by substituting one or more of transition metal atoms, which constitute a large part of any of the above lithium complex oxides, with another or other elements such as Na, K, B, F, Al, Ti, V, Cr, Mn, Fe, Co, Ni, Cu, Zn, Mg, Ca, Ga, Zr, Si, Nb, Mo, Sn, and/or W.

Examples of the lithium complex oxides each obtained by substituting one or more of transition metal atoms, which constitute a large part of any of the above lithium complex oxides, with another or other elements include: lithium cobalt complex oxides each having a layer structure and each represented by Formula (5) below; lithium nickel complex oxides each represented by Formula (6) below; lithium-manganese complex oxides each having a spinel structure and each represented by Formula (7) below; and solid solution lithium-containing transition metal oxides each represented by Formula (8) below.

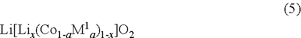

where: M¹ is at least one type of metal selected from the group consisting of Na, K, B, F, Al, Ti, V, Cr, Mn, Fe, Ni, Cu, Zn, Mg, Ga, Zr, Si, Nb, Mo, Sn, and W; and −0.1≤x≤0.30 and 0≤a≤0.5 are satisfied.

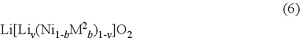

where: M² is at least one type of metal selected from the group consisting of Na, K, B, F, Al, Ti, V, Cr, Mn, Fe, Co, Cu, Zn, Mg, Ga, Zr, Si, Nb, Mo, Sn, and W; and −0.1≤y≤0.30 and 0≤b≤0.5 are satisfied.

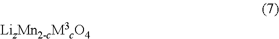

where: M³ is at least one type of metal selected from the group consisting of Na, K, B, F, Al, Ti, V, Cr, Fe, Co, Ni, Cu, Zn, Mg, Ga, Zr, Si, Nb, Mo, Sn, and W; and 0.9≤z and 0≤c≤1.5 are satisfied.

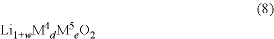

where: M⁴ and M⁵ are each independently at least one type of metal selected from the group consisting of Al, Ti, V, Cr, Mn, Fe, Co, Ni, Cu, Zn, Mg, and Ca; and 0<w≤⅓, 0≤d≤⅔, 0≤e≤⅔, and w+d+e=1 are satisfied.

Specific examples of the lithium complex oxides represented by Formulae (5) through (8) include LiCoO₂, LiNiO₂, LiMnO₂, LiNi_{0.8}Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiMn₂O₄, LiMn_{1.5}Ni_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, and Li_{1.07}Ni_{0.36}Co_{0.08}Mn_{0.49}O₂.

Lithium complex oxides other than the lithium complex oxides represented by Formulae (5) through (8) can be also preferably used as the positive electrode active material. Examples of such lithium complex oxides include LiNiVO₄, LiV₃O₆, and Li_{1.2}Fe_{0.4}Mn_{0.4}O₂.

Examples of a material which can be preferably used as the positive electrode active material, other than the lithium complex oxides, include phosphates each having an olivine-type structure. Specific examples of such phosphates include phosphates each having an olivine-type structure and each represented by the following Formula (9).

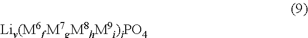

where: M⁶ is Mn, Co, or Ni; M⁷ is Ti, V, Cr, Mn, Fe, Co, Ni, Zr, Nb, or Mo; M⁸ is a transition metal, optionally excluding the elements in the groups VIA and VIIA, or a representative element; M⁹ is a transition metal, optionally excluding the elements in the groups VIA and VIIA, or a representative element; and 1.2≥a≥0.9, 1≥b≥0.6, 0.4≥c≥0, 0.2≥d≥0, 0.2≥e≥0, and 1.2≥f≥0.9 are satisfied.

In the positive electrode active material, each of surfaces of lithium metal complex oxide particles constituting the positive electrode active material is preferably coated with a coating layer. Examples of a material of which the coating layer is made include metal complex oxides, metal salts, boron-containing compounds, nitrogen-containing compounds, silicon-containing compounds, and sulfur-containing compounds. Among these materials, metal complex oxides are suitably used.

The metal complex oxides are preferably oxides each having lithium ion conductivity. Examples of such metal complex oxides include metal complex oxides of Li and at least one type of element selected from the group consisting of Nb, Ge, Si, P, Al, W, Ta, Ti, S, Zr, Zn, V, and B. When the positive electrode active material is a material particles of which each have a coating layer, the coating layer suppresses a side reaction which occurs at the interface between the positive electrode active material and the electrolyte substance at high voltages, and the resulting secondary battery can achieve a longer life. Moreover, the coating layer suppresses formation of a high-resistance layer at the interface between the positive electrode active material and the electrolyte substance, and the resulting secondary battery can achieve high output.

Examples of the electrically conductive agent include carbonaceous materials such as natural graphite, artificial graphite, cokes, carbon black, pyrolytic carbons, carbon fibers, and fired products of organic polymer compounds.

Examples of the binding agent include: thermoplastic resins such as polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include: a method which involves pressure-molding, on the positive electrode current collector, the positive electrode active material, the electrically conductive agent, and the binding agent which constitute a positive electrode mix; and a method which involves (i) forming, into a paste, the positive electrode active material, the electrically conductive agent, and the binding agent with use of an appropriate organic solvent to obtain the positive electrode mix, (ii) coating the positive electrode current collector with the positive electrode mix, (iii) drying the positive electrode mix, and then (iv) pressing the resulting sheet-shaped positive electrode mix on the positive electrode current collector so that the sheet-shaped positive electrode mix is firmly fixed to the positive electrode current collector.

### <Negative Electrode>

The negative electrode can be, for example, a negative electrode sheet having a structure in which an active material layer, containing a negative electrode active material and a binding agent, is formed on a current collector. The active material layer may further contain an electrically conductive agent.

Examples of the negative electrode active material include carbon materials, chalcogen compounds (such as oxides and sulfides), nitrides, metals, and alloys each of which is capable of being doped with and dedoped of lithium ions at electric potentials lower than that of the positive electrode.

Examples of the carbon materials which can be used as the negative electrode active material include graphites such as natural graphite and artificial graphite, cokes, carbon black, pyrolytic carbons, carbon fibers, and fired products of organic polymer compounds.

Examples of the oxides which can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VₓO_{y} (where x and y are each a positive real number), such as V₂O₅ and VO₂; oxides of iron which are represented by a formula FeₓO_{y} (where x and y are each a positive real number), such as Fe₃O₄, Fe₂O₃, and FeO; oxides of tin which are represented by a formula SnOₓ (where x is a positive real number) such as SnO₂ and SnO; oxides of tungsten which are represented by a general formula WOₓ (where x is a positive real number) such as WO₃ and WO₂; and complex metal oxides each of which contains lithium and titanium or vanadium, such as Li₄Ti₅O₁₂ and LiVO₂.

Examples of the sulfides which can be used as the negative electrode active material include: sulfides of titanium which are represented by a formula TiₓS_{y} (where x and y are each a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeₓS_{y} (where x and y are each a positive real number), such as Fe₃S₄, FeS₂, and FeS; sulfides of molybdenum which are represented by a formula MoₓS_{y} (where x and y are each a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbₓS_{y} (where x and y are each a positive real number), such as Sb₂S₃; and sulfides of selenium which are represented by a formula SeₓS_{y} (where x and y are each a positive real number), such as Se₅S₃, SeS₂, and SeS.

Examples of the nitrides which can be used as the negative electrode active material include lithium-containing nitrides such as Li₃N and Li₃₋ₓAₓN (where A is one or both of Ni and Co, and 0<x<3 is satisfied).

Each of these carbon materials, oxides, sulfides, and nitrides may be used alone or two or more of these carbon materials, oxides, sulfides, and nitrides may be used in combination. These carbon materials, oxides, sulfides, and nitrides can be each crystalline or amorphous. One or more of these carbon materials, oxides, sulfides, and nitrides are mainly supported by the negative electrode current collector, and the resulting negative electrode current collector is used as an electrode.

Examples of the metals which can be used as the negative electrode active material include lithium metals, silicon metals, and tin metals.

It is also possible to use a complex material which contains Si or Sn as a first constituent element and also contains second and/or third constituent elements. The second constituent element is, for example, at least one type of element selected from cobalt, iron, magnesium, titanium, vanadium, chromium, manganese, nickel, copper, zinc, gallium, and zirconium. The third constituent element is, for example, at least one type of element selected from boron, carbon, aluminum, and phosphorus.

In particular, since a high battery capacity and excellent battery characteristics are achieved, the above metal material is preferably a simple substance of silicon or tin (which may contain a slight amount of impurities), SiOᵥ (0<v≤2), SnO_{w} (0≤w≤2), an Si—Co—C complex material, an Si—Ni—C complex material, an Sn—Co—C complex material, or an Sn—Ni—C complex material.

Examples of the negative electrode current collector include Cu, Ni, and stainless steel. Among these materials, Cu is more preferable because Cu is not easily alloyed with lithium particularly in a lithium-ion secondary battery and is easily processed into a thin film.

Examples of a method of producing the negative electrode sheet include: a method which involves pressure-molding, on the negative electrode current collector, the negative electrode active material which constitutes a negative electrode mix; and a method which involves (i) forming the negative electrode active material into a paste with use of an appropriate organic solvent to obtain the negative electrode mix, (ii) coating the negative electrode current collector with the negative electrode mix, (iii) drying the negative electrode mix, and then (iv) pressing the resulting sheet-shaped negative electrode mix on the negative electrode current collector so that the sheet-shaped negative electrode mix is firmly fixed to the negative electrode current collector. The paste preferably contains an electrically conductive agent as described above and a binding agent as described above.

### <Nonaqueous Electrolyte>

The nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃) 2, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (BOB refers to bis(oxalato)borate), lower aliphatic carboxylic acid lithium salt, and LiAlCl₄. Each of these lithium salts may be used alone or two or more of these lithium salts may be used as a mixture. Among these lithium salts, it is preferable to use at least one fluorine-containing lithium salt selected from the group consisting of LiPF₆, LiAsF₆, LiSbF₆, LiBF₄, LiSO₃F, LiCF₃SO₃, LiN(SO₂CF₃)₂, and LiC(SO₂CF₃)₃.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N, N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into any of these organic solvents (i.e., compounds each prepared by substituting one or more hydrogen atoms of any of these organic solvents with one or more respective fluorine atoms).

The organic solvent is preferably a mixed solvent obtained by mixing two or more of the above organic solvents. Particularly, the organic solvent is preferably a mixed solvent containing a carbonate, further preferably a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte which contains such a mixed solvent has advantages of having a wider operating temperature range, being less prone to deterioration even when used at a high voltage, being less prone to deterioration even when used for a long period of time, and less prone to decomposition even when the negative electrode active material is a graphite material such as natural graphite or artificial graphite.

It is preferable to use, as the nonaqueous electrolyte, a nonaqueous electrolyte containing (i) a lithium salt containing fluorine (such as LiPF₆) and (ii) an organic solvent containing a fluorine substituent, because such a nonaqueous electrolyte allows the resulting nonaqueous electrolyte secondary battery to have increased safety. It is further preferable to use a mixed solvent containing a dimethyl carbonate and an ether having a fluorine substituent (such as pentafluoropropyl methylether or 2,2,3,3-tetrafluoropropyl difluoro methylether), because such a mixed solvent allows the resulting nonaqueous electrolyte secondary battery to have a high capacity maintenance ratio even when the nonaqueous electrolyte secondary battery is discharged at a high voltage.

### <Method of Producing Nonaqueous Electrolyte Secondary Battery Member and Method of Producing Nonaqueous Electrolyte Secondary Battery>

A method of producing the nonaqueous electrolyte secondary battery member can be, for example, a method which involves disposing the positive electrode, the nonaqueous electrolyte secondary battery laminated separator of an embodiment of the present invention, and the negative electrode in this order.

A method of producing the nonaqueous electrolyte secondary battery can be, for example, the following method. First, the nonaqueous electrolyte secondary battery member is placed in a container which is to be a housing of the nonaqueous electrolyte secondary battery. Next, the container is filled with the nonaqueous electrolyte, and then the container is hermetically sealed while pressure inside the container is reduced. In this manner, it is possible to produce the nonaqueous electrolyte secondary battery.

The present invention is not limited to the embodiments, but can be altered variously by a skilled person in the art within the scope of the claims. The present invention also encompasses, in its technical scope, any embodiment derived by appropriately combining technical means disclosed in differing embodiments.

An embodiment of the present invention may include the following features.

<1> A nonaqueous electrolyte secondary battery laminated separator constituted by a laminate of two or more layers, in which
the nonaqueous electrolyte secondary battery laminated separator has a tensile modulus during heating of not less than 0.25 in a region in which an elongation percentage is 50% to 200% in a tension test, where
the tension test is a test in which the nonaqueous electrolyte secondary battery laminated separator is elongated at a speed of 10 mm/min in a machine direction (MD) under an atmosphere at 120° C., and stress [unit: N] applied at that time is measured,
the elongation percentage is a percentage [unit: %] of an elongation amount [unit: mm] of the nonaqueous electrolyte secondary battery laminated separator in the MD relative to a length [unit: mm] of the nonaqueous electrolyte secondary battery laminated separator in the MD before the elongation, and
the tensile modulus during heating is an inclination of an approximation line with respect to a stress-strain n curve, the approximation line being obtained using a least squares method in the region in which the elongation percentage is 50% to 200%, and the stress-strain curve being obtained by plotting, where an X-axis value is the elongation percentage and a Y-axis value is the stress.

<2> The nonaqueous electrolyte secondary battery laminated separator of <1>, in which: the nonaqueous electrolyte secondary battery laminated separator has a structure in which a porous layer is laminated on one surface or both surfaces of a polyolefin porous film.

<3> The nonaqueous electrolyte secondary battery laminated separator of <1> or <2>, in which: at least one layer of the two or more layers is a heat-resistant layer.

<4> The nonaqueous electrolyte secondary battery laminated separator of any one of <1> through <3>, in which: at least one layer of the two or more layers is a layer which contains one or more types of resins selected from the group consisting of polyolefin, a (meth)acrylate-based resin, a fluorine-containing resin, a polyamide-based resin, a polyester-based resin, and a water-soluble polymer.

<5> The nonaqueous electrolyte secondary battery laminated separator of <4>, in which: the polyamide-based resin is an aramid resin.

<6> The nonaqueous electrolyte secondary battery laminated separator of <5>, in which:
the aramid resin is a block copolymer including
   a block A containing, as a main component, units each represented by Formula (3) below, and

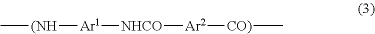

a block B containing, as a main component, units each represented by Formula (4) below,

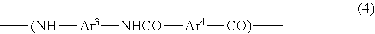

where
Ar¹, Ar², Ar³, and Ar⁴ may each vary from unit to unit,
Ar¹, Ar², Ar³, and Ar⁴ are each independently a divalent group having one or more aromatic rings,
not less than 50% of all Ar¹ each have a structure in which two aromatic rings are connected by a sulfonyl bond,
not more than 50% of all Ar³ each have a structure in which two aromatic rings are connected by a sulfonyl bond, and
10% to 70% of a total of all Ar¹ and Ar³ have a structure in which two aromatic rings are connected by a sulfonyl bond.

<7> The nonaqueous electrolyte secondary battery laminated separator of any one of <1> through <6>, in which: at least one layer of the two or more layers contains a filler; and an amount of the filler is 20% by weight to 90% by weight, relative to 100% by weight which is a total weight of each of the at least one layer containing the filler.

<8> The nonaqueous electrolyte secondary battery laminated separator of any one of <1> through <7>, in which: at least one layer of the two or more layers is an adhesive layer.

<9> A nonaqueous electrolyte secondary battery member, including a positive electrode, a nonaqueous electrolyte secondary battery laminated separator of any one of <1> through <8>, and a negative electrode, which are disposed in this order.

<10> A nonaqueous electrolyte secondary battery including a nonaqueous electrolyte secondary battery laminated separator of any one of <1> through <8>.

### EXAMPLES

The following description will discuss embodiments of the present invention in more detail with reference to Examples and Comparative Example. Note, however, that the present invention is not limited to such Examples and Comparative Example.

### [Methods of Measuring Various Physical Properties]

In Examples and Comparative Example below, physical properties were measured by methods below.

### <Thickness>

The thickness of the polyolefin porous film was measured with use of a high-precision digital measuring device (VL-50) manufactured by Mitutoyo Corporation.

### <Weight Per Unit Area>

From the polyolefin porous film, a square piece measuring 8 cm×8 cm was cut out as a sample. The weight of this sample was measured and regarded as W1 (g). Then, the weight per unit area of the polyolefin porous film was calculated according to the following Formula (10).

$$Weight per unit area ( g / {m}^{2} ) of polyolefin porous film = W 1 ( g ) / ( 0.08 \times 0.08 ) \qquad ( 10 )$$

From the laminated separator, a square piece measuring 8 cm×8 cm was cut out as a sample. The weight of this sample was measured and regarded as W2 (g). Then, the weight per unit area of the laminated separator was calculated according to the following Formula (11).

$$Weight per unit area ( g / {m}^{2} ) of laminated separator = W 2 ( g ) / ( 0.08 \times 0.08 ) \qquad ( 11 )$$

The weight per unit area of the polyolefin porous film was subtracted from the weight per unit area of the laminated separator, and thus the weight per unit area of the porous layer was calculated.

### <Tensile Modulus During Heating>

A tension test was carried out in which the laminated separator was elongated at a speed of 10 mm/min in the MD under an atmosphere at 120° C., by a method in conformance with the JIS K7127 standard. Stress [N] applied to the laminated separator and an elongation amount [mm] were measured at that time, and an elongation percentage [%] and a tensile modulus during heating were calculated based on the measurement results. Specifically, the tensile modulus during heating was calculated by a method including the following steps (a) through (e).
(a) The separator was punched out into a shape (distance between marked lines: 20 mm, width: 5 mm) defined by the dumbbell shape No. 3 described in JIS K6251 so that the MD was the longitudinal direction. As a result, the resulting laminated separator in a shape defined by the dumbbell shape No. 3 was used as a measurement sample.
(b) The measurement sample obtained in the step (a) was elongated at a speed of 10 mm/min in the MD under an atmosphere at 120° C. and, until the measurement sample completely broke, the stress [N], which was a load applied to the measurement sample, and the elongation amount [mm] were measured. At that time, measurement of the stress was carried out every time the elongation amount increased by 0.02 mm. More specifically, every time the elongation amount changed by 0.02 mm, stress, which was a load applied at that time, was measured. Here, specifically, the elongation amount after a predetermined time had elapsed from the start of the elongation was calculated according to the following Formula (1), where X₁ [mm] is a distance between the marked lines after a predetermined time has elapsed from the start of the elongation, and X₀ is a distance between the marked lines (i.e., 20 mm) prior to the elongation.

$$Elongation amount [ mm ] = {X}_{1} [ mm ] - {X}_{0} [ mm ] \qquad ( 1 )$$

(c) The elongation amount obtained in the step (b) was converted into an elongation percentage (unit: %) obtained by dividing the elongation amount by the distance between the marked lines (i.e., 20 mm) before the elongation in the step (b). Specifically, the elongation percentage after a predetermined time had elapsed from the start of the elongation was calculated according to the following Formula (2), where X₁ [mm] is a distance between the marked lines after a predetermined time has elapsed from the start of the elongation, and X₀ is a distance between the marked lines (i.e., 20 mm) prior to the elongation.

$$Elongation percentage [ \% ] = 100 \times ( {X}_{1} [ mm ] - {X}_{0} [ mm ] ) / {X}_{0} [ mm ] \qquad ( 2 )$$

A stress-strain curve was obtained by plotting, where a calculated value of the elongation percentage is an X axis (horizontal axis) and the stress is a Y axis (vertical axis).
(d) X of the stress-strain curve obtained in the step (c), i.e., in a range of the elongation percentage from 50% to 200%, a straight line was prepared with a least squares method, and an inclination of the straight line was calculated. The calculated inclination was regarded as a tensile modulus during heating.
   <Shape Retention Rate after Heating>

The laminated separator was cut out into a square piece measuring 80 mm×80 mm as a sample. On the surface of the porous layer constituting the sample, lines of a 60-mm square were drawn inside the outer edge of the 80-mm square. Thus, a measurement sample was obtained. The measurement sample was sandwiched between papers, and placed in an oven heated at 150° C. One hour later, the measurement sample was taken out from the oven. The length of the line drawn in the MD and the length of the line drawn in the TD of the measurement sample were measured with use of a digital vernier caliper. The length of the line drawn in the MD in the measurement sample which had been heated was regarded as DMD (mm). The DMD was used to calculate a value (unit: %) represented by Formula (12) below as a “shape retention rate after heating”.

$$( {D}_{MD} / 60 ) \times 100 \qquad ( 12 )$$

Here, it can be said that a shape retention rate after heating which is not less than 85% means that the laminated separator has excellent heat resistance.

### Production Example 1: Preparation of Coating Solution

A coating solution (1) was prepared according to the following procedure. An aramid resin contained in the coating solution (1) was a block copolymer containing a poly(4,4′-diphenylsulfonyl terephthalamide) block.
1. A separable flask having a capacity of 5 L and having a stirring blade, a thermometer, a nitrogen incurrent canal, and a powder addition port was sufficiently dried.
2. Into the flask, 4241 g of NMP was introduced. Further, 326.1 g of calcium chloride was added to the flask, and the resulting mixture was heated to 100° C. Thus, the calcium chloride was completely dissolved to obtain a solution of calcium chloride (7.14% by weight). Water was added to the calcium chloride solution so that a water content of the calcium chloride solution was calculated to be 450 ppm. Note that the calcium chloride used had been vacuum-dried at 200° C. for 2 hours in advance.
3. While the temperature of the polymerization system was maintained at 40° C., 141.76 g of 4,4′-diaminodiphenylsulfone (DDS) was added and completely dissolved.
4. The polymerization system was cooled to 25° C. While the temperature of the polymerization system was maintained at 25±2° C., 115.67 g in total of terephthalic acid dichloride (TPC) was added in three separate portions. Through a reaction for 1 hour, a block A1 composed of poly(4,4′-diphenylsulfonyl terephthalamide) was synthesized. At that time, a molar ratio between DDS and TPC was 1.002.
5. To the flask, 61.74 g of paraphenylenediamine (PPD) was added, and completely dissolved over 1 hour.
6. While the temperature of the polymerization system was maintained at 25±2° C., 113.08 g in total of TPC was added in three separate portions. Through a reaction for 1.5 hours, a block B1 composed of poly(paraphenylene terephthalamide) was elongated on both sides of the block A1. At that time, a molar ratio between PPD and TPC was 1.025.
7. While the temperature of the polymerization system was maintained at 20±2° C., the polymerization system was matured for 1 hour. In this manner, an aramid polymerization liquid (1) was obtained. In the block copolymer contained in the aramid polymerization liquid (1), the block A1 accounted for 50% of the entirety of a molecule and the block B1 accounted for the remaining 50% of the entirety of the molecule. The aramid polymerization liquid (1) contained the aramid resin containing the block copolymer.
8. To the aramid polymerization liquid (1), alumina (average particle diameter: 13 nm) was added and mixed. At that time, alumina was added so that a weight ratio between the alumina and the aramid resin containing the block copolymer was 1:1.
9. To the mixed solution obtained in the step 8, NMP was added as a diluent and calcium carbonate was added as a neutralizer so that a solid content was 4% by weight. The “solid content” here means a proportion of the aramid resin and the alumina. This solution was stirred for 20 minutes so as to be diluted and neutralized. This neutralized solution was defoamed under reduced pressure, and thus a coating solution (1) in slurry form was prepared.

### Production Example 2: Preparation of Coating Solution

A coating solution (2) in slurry form was prepared by carrying out operations similar to those in the steps 1 through 9 of Production Example 1, except that the weight ratio between the aramid resin and the alumina in the step 8 was changed to 3:1.

### Production Example 3: Preparation of Coating Solution

A coating solution (3) was prepared according to the following procedure. An aramid resin contained in the coating solution (3) was a block copolymer containing a poly(4,4′-diphenylsulfonyl terephthalamide) block.
1. A separable flask having a capacity of 5 L and having a stirring blade, a thermometer, a nitrogen incurrent canal, and a powder addition port was sufficiently dried.
2. Into the flask, 4241 g of NMP was introduced. Further, 326.1 g of calcium chloride was added to the flask, and the resulting mixture was heated to 100° C. Thus, the calcium chloride was completely dissolved to obtain a solution of calcium chloride (7.14% by weight). Water was added to the calcium chloride solution so that a water content of the calcium chloride solution was calculated to be 450 ppm. Note that the calcium chloride used had been vacuum-dried at 200° C. for 2 hours in advance.
3. While the temperature of the polymerization system was maintained at 40° C., 141.61 g of DDS was added and completely dissolved.
4. The polymerization system was cooled to 25° C. While the temperature of the polymerization system was maintained at 25±2° C., 116.13 g in total of TPC was added in three separate portions. Through a reaction for 1 hour, a block A2 composed of poly(4,4′-diphenylsulfonyl terephthalamide) was synthesized. At that time, a molar ratio between DDS and TPC was 0.997.
5. To the flask, 61.67 g of PPD was added, and completely dissolved over 1 hour.
6. While the temperature of the polymerization system was maintained at 25±2° C., 112.96 g in total of TPC was added in three separate portions. Through reaction for 1.5 hours, a block B2 composed of poly(paraphenylene terephthalamide) was elongated on both sides of the block A2. At that time, a molar ratio between PPD and TPC was 1.025.
7. While the temperature of the polymerization system was maintained at 20±2° C., the polymerization system was matured for 1 hour. In this manner, an aramid polymerization liquid (3) was obtained. In the block copolymer contained in the aramid polymerization liquid (3), the block A2 accounted for 50% of the entirety of a molecule and the block B2 accounted for the remaining 50% of the entirety of the molecule. The aramid polymerization liquid (3) contained the aramid resin containing the block copolymer.
8. To the aramid polymerization liquid (3), alumina (average particle diameter: 13 nm) was added and mixed. At that time, alumina was added so that a weight ratio between the alumina and the aramid resin containing the block copolymer was 1:1.
9. To the mixed solution obtained in the step 8, NMP was added as a diluent and calcium carbonate was added as a neutralizer so that a solid content was 4% by weight. The “solid content” here means a proportion of the aramid resin and the alumina. This solution was stirred for 20 minutes so as to be diluted and neutralized. This neutralized solution was defoamed under reduced pressure, and thus a coating solution (3) in slurry form was prepared.

### Production Example 4

A coating solution (4) in slurry form was prepared by carrying out operations similar to those in the steps 1 through 9 of Production Example 3, except that the weight ratio between the aramid resin and the alumina in the step 8 was changed to 3:1.

### Production Example 5

A coating solution (5) was prepared according to the following procedure. An aramid resin contained in the coating solution (5) was a block copolymer containing a poly(4,4′-diphenylsulfonyl terephthalamide) block.
1. A separable flask having a capacity of 5 L and having a stirring blade, a thermometer, a nitrogen incurrent canal, and a powder addition port was sufficiently dried.
2. Into the flask, 4241 g of NMP was introduced. Further, 326.1 g of calcium chloride was added to the flask, and the resulting mixture was heated to 100° C. Thus, the calcium chloride was completely dissolved to obtain a solution of calcium chloride (7.14% by weight). Water was added to the calcium chloride solution so that a water content of the calcium chloride solution was calculated to be 450 ppm. Note that the calcium chloride used had been vacuum-dried at 200° C. for 2 hours in advance.
3. While the temperature of the polymerization system was maintained at 40° C., 141.70 g of DDS was added and completely dissolved.
4. The polymerization system was cooled to 25° C. While the temperature of the polymerization system was maintained at 25±2° C., 115.86 g in total of TPC was added in three separate portions. Through a reaction for 1 hour, a block A3 composed of poly(4,4′-diphenylsulfonyl terephthalamide) was synthesized. At that time, a molar ratio between DDS and TPC was 1.00.
5. To the flask, 61.71 g of PPD was added, and completely dissolved over 1 hour.
6. While the temperature of the polymerization system was maintained at 25±2° C., 113.03 g in total of TPC was added in three separate portions. Through a reaction for 1.5 hours, a block B3 composed of poly(paraphenylene terephthalamide) was elongated on both sides of the block A3. At that time, a molar ratio between PPD and TPC was 1.025.
7. While the temperature of the polymerization system was maintained at 20±2° C., the polymerization system was matured for 1 hour. In this manner, an aramid polymerization liquid (5) was obtained. In the block copolymer contained in the aramid polymerization liquid (5), the block A3 accounted for 50% of the entirety of a molecule and the block B3 accounted for the remaining 50% of the entirety of the molecule. The aramid polymerization liquid (5) contained the aramid resin containing the block copolymer.
8. To the aramid polymerization liquid (5), alumina (average particle diameter: 13 nm) was added and mixed. At that time, alumina was added so that a weight ratio between the alumina and the aramid resin containing the block copolymer was 2:1.
9. To the mixed solution obtained in the step 8, NMP was added as a diluent and calcium carbonate was added as a neutralizer so that a solid content was 4% by weight. The “solid content” here means a proportion of the aramid resin and the alumina. This solution was stirred for 20 minutes so as to be diluted and neutralized. This neutralized solution was defoamed under reduced pressure, and thus a coating solution (5) in slurry form was prepared.

### Production Example 6

A coating solution (6) was prepared according to the following procedure. An aramid resin contained in the coating solution (6) was a block copolymer containing a poly(4,4′-diphenylsulfonyl terephthalamide) block.
1. A separable flask having a capacity of 5 L and having a stirring blade, a thermometer, a nitrogen incurrent canal, and a powder addition port was sufficiently dried.
2. Into the flask, 4234 g of NMP was introduced. Further, 325.5 g of calcium chloride was added to the flask, and the resulting mixture was heated to 100° C. Thus, the calcium chloride was completely dissolved to obtain a solution of calcium chloride (7.14% by weight). Water was added to the calcium chloride solution so that a water content of the calcium chloride solution was calculated to be 450 ppm. Note that the calcium chloride used had been vacuum-dried at 200° C. for 2 hours in advance.
3. While the temperature of the polymerization system was maintained at 40° C., 94.01 g of DDS was added and completely dissolved.
4. The polymerization system was cooled to 25° C. While the temperature of the polymerization system was maintained at 25±2° C., 77.25 g in total of TPC was added in three separate portions. Through a reaction for 1 hour, a block A4 composed of poly(4,4′-diphenylsulfonyl terephthalamide) was synthesized. At that time, a molar ratio between DDS and TPC was 0.995.
5. To the flask, 95.53 g of PPD was added, and completely dissolved over 1 hour.
6. While the temperature of the polymerization system was maintained at 25±2° C., 173.29 g in total of TPC was added in three separate portions. Through a reaction for 1.5 hours, a block B4 composed of poly(paraphenylene terephthalamide) was elongated on both sides of the block A4. At that time, a molar ratio between PPD and TPC was 1.035.
7. While the temperature of the polymerization system was maintained at 20±2° C., the polymerization system was matured for 1 hour. In this manner, an aramid polymerization liquid (6) was obtained. In the block copolymer contained in the aramid polymerization liquid (6), the block A4 accounted for 30% of the entirety of a molecule and the block B4 accounted for the remaining 70% of the entirety of the molecule. The aramid polymerization liquid (6) contained the aramid resin containing the block copolymer.
8. To the aramid polymerization liquid (6), alumina (average particle diameter: 13 nm) was added and mixed. At that time, alumina was added so that a weight ratio between the alumina and the aramid resin containing the block copolymer was 1:1.
9. To the mixed solution obtained in the step 8, NMP was added as a diluent and calcium carbonate was added as a neutralizer so that a solid content was 4% by weight. The “solid content” here means a proportion of the aramid resin and the alumina. This solution was stirred for 20 minutes so as to be diluted and neutralized. This neutralized solution was defoamed under reduced pressure, and thus a coating solution (6) in slurry form was prepared.

### Comparative Production Example 1

A coating solution (7) was prepared according to the following procedure. An aramid resin contained in the coating solution (7) was a block copolymer containing a poly(4,4′-diphenylsulfonyl terephthalamide) block.
1. A separable flask having a capacity of 5 L and having a stirring blade, a thermometer, a nitrogen incurrent canal, and a powder addition port was sufficiently dried.
2. Into the flask, 4202 g of NMP was introduced. Further, 365.9 g of calcium chloride was added to the flask, and the resulting mixture was heated to 100° C. Thus, the calcium chloride was completely dissolved to obtain a solution of calcium chloride (7.14% by weight). Water was added to the calcium chloride solution so that a water content of the calcium chloride solution was calculated to be 300 ppm. Note that the calcium chloride used had been vacuum-dried at 200° C. for 2 hours in advance.
3. While the temperature of the polymerization system was maintained at 40° C., 141.97 g of DDS was added and completely dissolved.
4. The polymerization system was cooled to 16° C. While the temperature of the polymerization system was maintained at 16±2° C., 114.25 g in total of TPC was added in three separate portions. Through a reaction for 1 hour, a block A5 composed of poly(4,4′-diphenylsulfonyl terephthalamide) was synthesized. At that time, a molar ratio between DDS and TPC was 1.016.
5. To the flask, 61.83 g of PPD was added, and completely dissolved over 1 hour.
6. While the temperature of the polymerization system was maintained at 18±2° C., 114.03 g in total of TPC was added in three separate portions. Through a reaction for 1.5 hours, a block B5 composed of poly(paraphenylene terephthalamide) was elongated on both sides of the block A5. At that time, a molar ratio between PPD and TPC was 1.018.
7. While the temperature of the polymerization system was maintained at 20±2° C., the polymerization system was matured for 1 hour. In this manner, an aramid polymerization liquid (7) was obtained. In the block copolymer contained in the aramid polymerization liquid (7), the block A5 accounted for 50% of the entirety of a molecule and the block B5 accounted for the remaining 50% of the entirety of the molecule. The aramid polymerization liquid (7) contained the aramid resin containing the block copolymer.
8. To the aramid polymerization liquid (7), alumina (average particle diameter: 13 nm) was added and mixed. At that time, alumina was added so that a weight ratio between the alumina and the aramid resin containing the block copolymer was 1:1.
9. To the mixed solution obtained in the step 8, NMP was added as a diluent and calcium carbonate was added as a neutralizer so that a solid content was 4% by weight. The “solid content” here means a proportion of the aramid resin and the alumina. This solution was stirred for 20 minutes so as to be diluted and neutralized. This neutralized solution was defoamed under reduced pressure, and thus a coating solution (7) in slurry form was prepared.

### Example 1

While transferring the porous film (polyethylene porous film, thickness: 9 μm, weight per unit area: 5 g/m²), the coating solution (1) in slurry form produced in Production Example 1 was applied to one surface (front surface) of the porous film. As a result, a coating film was formed on one surface of the porous film. Subsequently, while the porous film on which the coating film had been formed was transferred, the coating film and the porous film were passed through a deposition tank which was set at 50° C. and relative humidity of 70%. Thus, the coating film was exposed to air containing water vapor at 50° C. and relative humidity of 70%. Thus, a block copolymer was deposited on one surface (front surface) of the porous film, and a coating layer was formed. Next, by cleaning, with water, a laminated body constituted by the porous film and the coating layer deposited on one surface of the porous film, calcium chloride and the solvent were removed from the coating layer. Subsequently, by drying the laminated body, a laminated separator (1) in which the porous layer was formed on one surface of the porous film was obtained.

### Example 2

A laminated separator (2) was obtained by carrying out operations similar to those in Example 1, except that the coating solution (2) in slurry form produced in Production Example 2 was used instead of the coating solution (1) in slurry form.

### Example 3

A laminated separator (3) was obtained by carrying out operations similar to those in Example 1, except that the coating solution (3) in slurry form produced in Production Example 3 was used instead of the coating solution (1) in slurry form.

### Example 4

A laminated separator (4) was obtained by carrying out operations similar to those in Example 1, except that the coating solution (4) in slurry form produced in Production Example 4 was used instead of the coating solution (1) in slurry form.

### Example 5

A laminated separator (5) was obtained by carrying out operations similar to those in Example 1, except that the coating solution (5) in slurry form produced in Production Example 5 was used instead of the coating solution (1) in slurry form.

### Example 6

A laminated separator (6) was obtained by carrying out operations similar to those in Example 1, except that the coating solution (6) in slurry form produced in Production Example 6 was used instead of the coating solution (1) in slurry form.

### Comparative Example 1

A comparative laminated separator (1) was obtained by carrying out operations similar to those in Example 1, except that the coating solution (7) in slurry form produced in Comparative Production Example 1 was used instead of the coating solution (1) in slurry form.

### Results

Table 1 below indicates the tensile modulus during heating, the weight per unit area of the porous layer, and the shape retention rate after heating in each of the laminated separators (1) through (6) and the comparative laminated separator (1) described in Examples 1 through 6 and Comparative Example 1.

TABLE 1

| | | Weight per unit | Shape retention |
|---|---|---|---|
| | Tensile modulus | area of porous | rate after |
| | during heating | layer [g/m²] | heating [%] |
| Example 1 | 0.33 | 1.7 | 96.6 |
| Example 2 | 0.27 | 1.8 | 97.9 |
| Example 3 | 0.27 | 1.6 | 95.5 |
| Example 4 | 0.29 | 1.7 | 93.7 |
| Example 5 | 0.26 | 1.4 | 95.7 |
| Example 6 | 0.28 | 1.7 | 96.2 |
| Comparative | 0.23 | 1.6 | 82.5 |
| Example 1 | | | |

As indicated in Table 1, the laminated separators (1) through (6) described in Examples 1 through 6 had large values of the tensile modulus during heating which were not less than 0.25, whereas the comparative laminated separator (1) described in Comparative Example 1 had a tensile modulus during heating of less than 0.25. Thus, the laminated separators (1) through (6) described in Examples 1 through 6 fall under the laminated separator of an embodiment of the present invention.

As indicated in Table 1, the laminated separators (1) through (6) described in Examples 1 through 6 have high shape retention rates after heating of not less than 85%, and are more excellent than the comparative laminated separator (1) described in Comparative Example 1 in terms of heat resistance.

As described above, it has been indicated that the laminated separator of an embodiment of the present invention has excellent heat resistance.

### INDUSTRIAL APPLICABILITY

The laminated separator of an embodiment of the present invention has excellent heat resistance. Therefore, according to the laminated separator, a short circuit caused due to contraction of the separator by heat generated during operation is suitably prevented, and thus the laminated separator can be used in production of a nonaqueous electrolyte secondary battery which has excellent safety.

1. A nonaqueous electrolyte secondary battery laminated separator constituted by a laminate of two or more layers, wherein
said nonaqueous electrolyte secondary battery laminated separator has a tensile modulus during heating of not less than 0.25 in a region in which an elongation percentage is 50% to 200% in a tension test, where
the tension test is a test in which said nonaqueous electrolyte secondary battery laminated separator is elongated at a speed of 10 mm/min in a machine direction (MD) under an atmosphere at 120° C., and stress [unit: N] applied at that time is measured,
the elongation percentage is a percentage [unit: %] of an elongation amount [unit: mm] of said nonaqueous electrolyte secondary battery laminated separator in the MD relative to a length [unit: mm] of said nonaqueous electrolyte secondary battery laminated separator in the MD before the elongation, and
the tensile modulus during heating is an inclination of an approximation line with respect to a stress-strain curve, the approximation line being obtained using a least squares method in the region in which the elongation percentage is 50% to 200%, and the stress-strain curve being obtained by plotting, where an X-axis value is the elongation percentage and a Y-axis value is the stress.

2. The nonaqueous electrolyte secondary battery laminated separator of claim 1, wherein:
said nonaqueous electrolyte secondary battery laminated separator has a structure in which a porous layer is laminated on one surface or both surfaces of a polyolefin porous film.

3. The nonaqueous electrolyte secondary battery laminated separator of claim 1, wherein:
at least one layer of the two or more layers is a heat-resistant layer.

4. The nonaqueous electrolyte secondary battery laminated separator of claim 1, wherein:
at least one layer of the two or more layers is a layer which contains one or more types of resins selected from the group consisting of polyolefin, a (meth)acrylate-based resin, a fluorine-containing resin, a polyamide-based resin, a polyester-based resin, and a water-soluble polymer.

5. The nonaqueous electrolyte secondary battery laminated separator of claim 4, wherein:
the polyamide-based resin is an aramid resin.

6. The nonaqueous electrolyte secondary battery laminated separator of claim 5, wherein:
the aramid resin is a block copolymer including
a block A containing, as a main component, units each represented by Formula (3) below, and 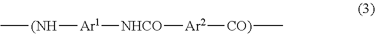
a block B containing, as a main component, units each represented by Formula (4) below, 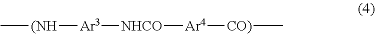
where
Ar¹, Ar², Ar³, and Ar⁴ may each vary from unit to unit,
Ar¹, Ar², Ar³, and Ar⁴ are each independently a divalent group having one or more aromatic rings,
not less than 50% of all Ar¹ each have a structure in which two aromatic rings are connected by a sulfonyl bond,
not more than 50% of all Ar³ each have a structure in which two aromatic rings are connected by a sulfonyl bond, and
10% to 70% of a total of all Ar¹ and Ar³ have a structure in which two aromatic rings are connected by a sulfonyl bond.

7. The nonaqueous electrolyte secondary battery laminated separator of claim 1, wherein:
at least one layer of the two or more layers contains a filler; and
an amount of the filler is 20% by weight to 90% by weight, relative to 100% by weight which is a total weight of each of the at least one layer containing the filler.

8. The nonaqueous electrolyte secondary battery laminated separator of claim 1, wherein:
at least one layer of the two or more layers is an adhesive layer.

9. A nonaqueous electrolyte secondary battery member, comprising a positive electrode, a nonaqueous electrolyte secondary battery laminated separator of claim 1, and a negative electrode, which are disposed in this order.

10. A nonaqueous electrolyte secondary battery comprising a nonaqueous electrolyte secondary battery laminated separator of claim 1.
